(19) United States
(12) Patent Application Publication
(10) Pub. No.: US 2013/0074294 A1
(43) Pub. Date: Mar. 28, 2013

(54) Adjustable jaw table clamp

(71) Applicant: James C. Lynch, Savannah, GA (US)

(72) Inventor: James C. Lynch, Savannah, GA (US)

(21) Appl. No.: 13/200,505

(22) Filed: Sep. 23, 2011

(51) Int. Cl. F16B 2/12

(52) U.S. Cl. 24/535; 24/568

(57) ABSTRACT

An adjustable jaw table clamp apparatus for quickly and easily attaching table cover and skirting to a table. The disclosed apparatus provides a lightweight, easy to manufacture clamping device that is adjustable. There is disclosed a clamping apparatus that is adjustable and can fit various table thicknesses with a design that is universal and can accommodate the thicknesses of different table top sizes. The apparatus comprises a variably adjusting clamping device that is easy to use and may be reusable.

### FIELD OF INVENTION

The present invention relates to a clamp apparatus for detachably connecting a table cover to a skirt adjacent to the edges of a table.

### BACKGROUND

Table covers are used on a variety of types of tables such as dining tables, banquet tables, and speaker stands, for example. It is often necessary to remove them, as when they get soiled or wrinkled. However, at the same time they need to be retained in place especially in applications where they are subjected to various outside influences such as wind in an outside environment, movement about a banquet hall, on a veranda or in outside restaurants. Also, for table covers that have or consist only of a separate overhanging skirt portion, a way to easily detachably connect them to the table is necessary.

Heretofore, clips connectable to the edge of a table were provided with grommets that snapped into sockets in a strip of material sewn onto table skirts. However, these devices required that clips be precisely located on the table to match the locations of sockets on the skirt. This is often cumbersome and difficult to do. Moreover, as table top thicknesses vary, different clip sizes would be needed which could also be unnecessarily cumbersome when dealing with the various sizes.

Accordingly, there is a need for a means for attaching a table cover and/or the skirting to a table with an easy to use clamping apparatus that can adjustably fit various table sizes.

### SUMMARY

The present invention addresses the above-described deficiencies and others. Specifically, the present invention provides a clamp apparatus for quickly and easily attaching table cover and skirting to a table. Accordingly, it is an object of the present invention to provide a lightweight, easy to manufacture clamping device. In accordance with an aspect of the present disclosure, there is disclosed a clamping apparatus that is adjustable and can fit various table thicknesses with a design that is universal and can accommodate the thicknesses of different table tops. In accordance with yet another object of the invention is disclosed a variably adjusting clamping device that is easy to use and may be reusable.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

### BRIEF DESCRIPTION OF THE DRAWINGS

Embodiments of the present disclosure are described herein with reference to the drawings, in which:

FIG. 1 is a perspective diagram of the adjustable jaw clamping apparatus in accordance with an embodiment of the present invention;

FIG. 2 is a top view of the adjustable jaw clamping apparatus, in accordance with an embodiment of the present invention;

FIG. 3 is perspective view of an alternate embodiment of the adjustable jaw clamping apparatus with an alternate slide jaw adjusting means, according to certain embodiments of the present disclosure; and

FIG. 4 is perspective view of another embodiment of the adjustable jaw clamping apparatus with an alternate slide jaw adjusting means, according to certain embodiments of the present disclosure.

The novel features which are characteristic of the invention, as to organization and method of use, together with further objects and advantages thereof, will be better understood from the following disclosure considered in connection with the accompanying drawings in which one or more preferred embodiments of the invention are illustrated by way of example. It is to be expressly understood, however, that the drawings are for the purpose of illustration and description only and are not intended as a definition of the limits of the invention.

As used herein, the term “comprises” refers to a part or parts of a whole, but does not exclude other parts. That is, the term “comprises” is open language that requires the presence of the recited element or structure or its equivalent, but does not exclude the presence of other elements or structures. The term “comprises” has the same meaning and is interchangeable with the terms “includes” and “has”. The term set has the meaning of one or more of said element. Furthermore, any use of the term “or” as used herein is generally intended to mean “and/or” unless otherwise indicated. Combinations of components or steps will also be considered as being noted, where terminology is foreseen as rendering the ability to separate or combine is unclear.

### DETAILED DESCRIPTION

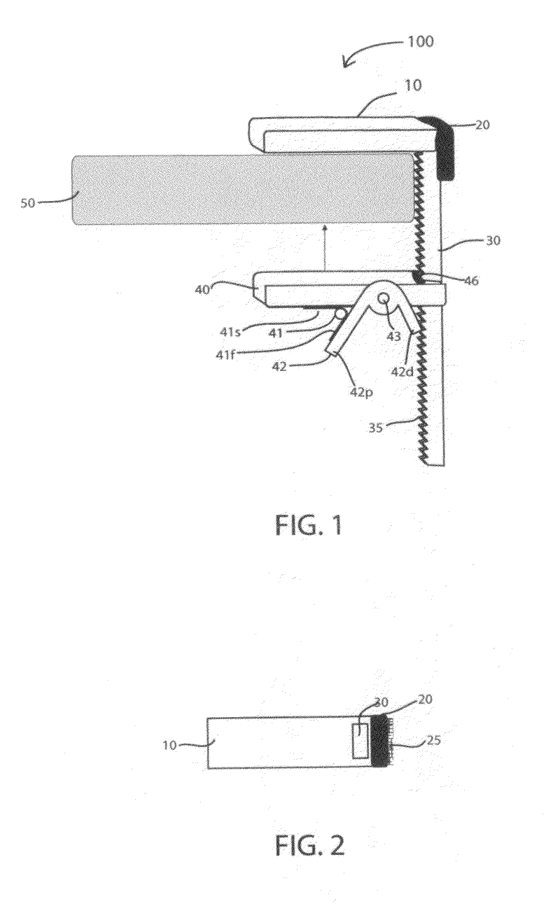

Referring now to the figures, FIG. 1 is a perspective diagram of an embodiment of the adjustable jaw clamping apparatus (AJC) 100. The AJC 100 is comprised of a fixed jaw 10 with a fastening means 20, and a rod 30 attached to both said fixed jaw 10 and a operatively connected to a movable slide jaw 40. FIG. 2 illustrates a top view of the AJC 100 illustrating the upper fixed jaw 10 in relation to the rod 30 and fastening means 20.

Referring again to FIG. 1, there is shown a pictorial table's edge 50 that the respective jaws of the AJC 100 clamp onto in an adjustable fashion. As the upper, fixed jaw 10 is placed on the upper side of a table's edge 50 as illustrated and the lower, slide jaw 40 is moved in the direction depicted by the arrow via a spring adjusted trigger mechanism comprising a spring 41, a trigger 42 operatively coupled to the slide jaw 40 by way of a connecting pin 43. The trigger 42 has a proximal end and first leg 42p which operatively engages a respective first leg 41f of the spring 41. Furthermore, the trigger 42 has a distal end and second leg 42d that operatively engages the inner side of the rod 30.

The inner side of the rod 30 is serrated with an array of serrations, grooves, notches, or the like, 35, which frictionally and mechanically engage the distal end of the trigger 42d such that the slide jaw 40 may be adjustably moved upward along the length of the rod 30 and may also be maintained in a fixed position once the slide jaw 40 is adjacent the table's edge 50. The serrations 35 provide the frictional engagement for placement of the trigger 42. The spring 41 operatively engages both said slide jaw 40 and said trigger 42 due to compression forces generated by the coil turns of the spring center 41c.

The second leg of the spring 41s is pressed against the underside of the slide jaw 40 for aiding in providing upward and downward mobility of said slide jaw 40. The slide jaw 40 has a recessed portion having a groove or recess 46 which at least partially surrounds said rod 30 for facilitating translational movement of the slide jaw 40 with relation to the rod 30 along a longitudinal axis of said rod 30. The spring 41 may be coupled to the trigger 42 and slide jaw 40 by known bonding and/or attaching means well known to an artisan of skill in the art.

The fixed jaw 10, fastening means 20, and the rod 30 are all integrally connected by either a bonding means known in the art, such as for example, chemical bonding via epoxies, or the like and/or a mechanical bonding such as manufacturing molding process well known in the art. The fastening means 20 has at least two sides wherein a first side is connected to the fixed jaw 10 and rod 30 and a second side providing attachment means 25 for connecting to a table cover. The attachment means 25 may be a hook and loop fastening mechanism such as a Velcro strip (as depicted in FIG. 2), or button, or loops, or equivalent fastening means, for attaching the AJC 100 to a table cover.

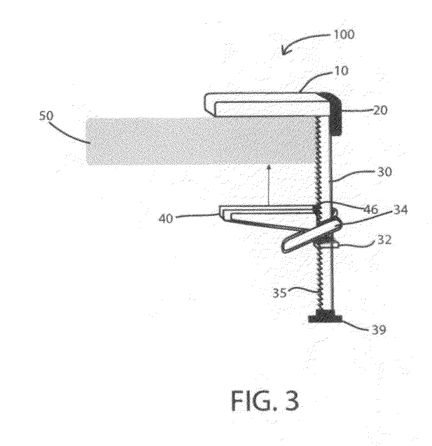

FIG. 3 illustrates another embodiment of the AJC 100 wherein an alternate mechanism for translating the slide jaw 40 is employed. In this embodiment, the lower slide jaw 40 is frictionally engaged on rod 30 serving as a linear ratchet shaft and moves up and down along the serrations 35 of the rod 30 and thus avoiding back slip. Stopper 32 serves to keep the jaw 40 in place along the serrations 35 while the dog lever 34 can be manually depressed to release the frictional engagement on the serrations 35 and to thus translate the jaw 40 either up or down the rod 30. A base 39 serves to engage with stopper 32 to limit the lower most position of the jaw 40.

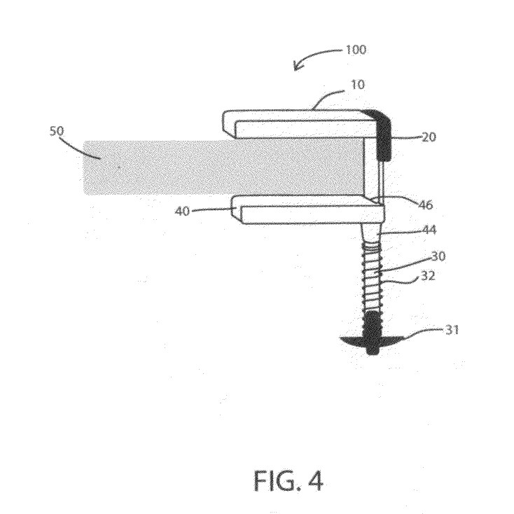

FIG. 4 illustrates yet another embodiment of the AJC 100 having an alternative mechanism for translating the slide jaw 40. Shown in a closed position about table's edge 50, the slide jaw 40 has a spring-loaded mechanism that facilitates the abutment of the lower jaw 40 against the table's edge 50 by way of the coil spring 32 coiled longitudinally about rod 30. The coil spring 30 exerts compression forces outwardly on both the stop member 31 as well as slide jaw stopper 44. The slide jaw stopper 44 is sized and configured such that the diameter is greater than the diameter of the coil spring 30. The distal end of the rod 30 has a stop member 31 having a diameter larger than the diameter of the coil spring 32 and operatively connected to said rod 30 such that it serves to keep the coil spring 30 in place along the rod 30 and thereby facilitating translational movement of lower jaw 40.

In each of the embodiments, the AJC 100 may be sized and dimensioned to fit about varying sizes of tables. In some embodiments, however, the approximate length of the AJC 100 may be about 2-5 inches and having a width in the range of 0.5 to 1 inch wide ad weighing less than 6 ounces, depending on materials. The upper fixed jaw 10, slide jaw 40, fastening means 20, and the rod 30 may be comprised of any suitable, light weight plastic, such as for example, acetyl, polypropylene, nylon, ABS, high density polystyrene, impact modified polypropylene, and/or combinations thereof. The attachment means 25 and the fastening means 20 may be of the same width of the rod 30 and fixed jaw 10; and moreover, the width of the rod 30 is the same as the fixed jaw 10. The upper fixed jaw 10 may be the same size and dimension as the slide jaw 40.

It is to be appreciated that one or more of the elements depicted in the drawings/figures can also be implemented in a more separated or integrated manner, or even removed or rendered as inoperable in certain cases, as is useful in accordance with a particular application. Thus, while the present invention has been described herein with reference to particular embodiments thereof, a latitude of modification, various changes and substitutions are intended in the foregoing disclosures, and it will be appreciated that in some instances, some features of embodiments of the invention will be employed without a corresponding use of other features without departing from the scope and spirit of the invention as set forth.

Therefore, many modifications may be made to adapt a particular situation or material to the essential scope and spirit of the present invention. It is intended that the invention not be limited to the particular terms used and/or to the particular embodiment disclosed as the best mode contemplated for carrying out this invention, but that the invention will include any and all embodiments and equivalents falling within the scope of the instant disclosure.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

1. An adjustable jaw table clamp for securing a table cover adjacent the edge of a table top comprising:
a fixed jaw;
a movable jaw, said movable jaw located in a plane parallel to said fixed jaw;
a rod, said rod operatively connected to and perpendicular to both said fixed and said movable jaw;
an adjustment mechanism operatively connected to said movable jaw and said rod, for actuating translational movement along a longitudinal axis of said rod to thereby move said movable jaw relative to said fixed jaw and said movement resulting in closer proximity of said jaws to one another to thereby engage and clamp the edge of a table; and
attachment means operatively connected to said fixed jaw and said rod, said attachment means having fastening means for removably fastening said attachment means to a table cover.

2. The adjustable jaw table clamp of claim 1, wherein
said rod having longitudinal movement means for providing adjustable translational movement along said rod.

3. The adjustable jaw table clamp of claim 2, wherein
said movable jaw comprises a recessed portion for at least partially surrounding said rod for facilitating translational longitudinal movement along said rod

4. The adjustable jaw table clamp of claim 3, wherein
said fastening means comprises hook and loop-type fasteners for attaching said table clamp to a table cover.

5. The adjustable jaw table clamp of claim 4, wherein
said rod comprises at least one serrated longitudinal surface for frictionally and mechanically engaging said adjustment mechanism.

6. The adjustable jaw table clamp of claim 5, wherein
said adjustment mechanism comprises a spring trigger mechanism for actuating longitudinal movement translationally along said rod.

7. The adjustable jaw table clamp of claim 6, wherein
said spring trigger mechanism comprises a spring and a trigger operatively connected to said movable jaw;
and said trigger connected to said movable jaw by a connecting pin.

8. The adjustable jaw table clamp of claim 4, wherein
said adjustment mechanism comprises a coil spring and stop mechanism; and
said coil spring being circumferentially wound about said rod.

9. The adjustable jaw table clamp of claim 8, wherein
said coil spring having a diameter slightly larger than said rod and less than said stop mechanism.

10. The adjustable jaw table clamp of claim 9, wherein
said movable jaw comprises a stopper portion at a distal end thereof, and said stopper portion having a diameter larger than the diameter of said coil spring; and
said stop mechanism operatively connected to a distal end of said rod.

11. The adjustable jaw table clamp of claim 4, wherein
said adjustment mechanism comprises a ratchet means having a dog lever and a stopper operatively connected to said movable jaw for actuating movement along a longitudinal axis of said rod.
